(19) United States
(12) Patent Application Publication
(10) Pub. No.: US 2005/0170066 A1
(43) Pub. Date: Aug. 4, 2005

(54) Process of making a bacon-like meat product of reduced fat content

(76) Inventor: James M. Greathouse, Salem, IN (US)

Correspondence Address: BOWERS HARRISON LLP;GARY K. PRICE, ESP., 25 RIVERSIDE DRIVE, PO BOX 1287, EVANSVILLE, IN, 47706-1287, US

(21) Appl. No.: 11/039,622

(22) Filed: Jan. 20, 2005

Related U.S. Application Data
(60) Provisional application No. 60/540,049, filed on Jan. 30, 2004.

(51) Int. Cl. A23L 1/31

(52) U.S. Cl. 426/641

(57) ABSTRACT

A meat product of controlled lean meat content that preferably takes the form of and may be a substitute for bacon or similar sliced meat products. The lean meat product is produced by grounding approximately 40% of the total meat product through a fine ground aperture plate. The fine ground meat is placed into a mixer with the balance of the lean meat. Seasonings and water are further added to the mixer and mixing proceeds for about 5 minutes. The mixture is next ground through a coarse ground aperture plate. The resulting material is transferred into pans that are placed into a smoke house.

### CROSS REFERENCES TO RELATED APPLICATIONS

U.S. Provisional Application for Patent No. 60/540,049, filed Jan. 30, 2004, with title “Process of Making a Bacon-Like Product of Reduced Fat Content” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

This invention relates generally to a new and improved meat product and process for its preparation. More particularly, it relates to a new and improved meat product of controlled lean meat content that preferably takes the form of and may be a substitute for high fat bacon or similar sliced meat products.

2. Brief Description of Prior Art

As is well known, slabs of cured and/or smoked bacon cut from the carcass of a pig generally contain an inordinately high fat content. The bacon which is conventionally cut into oblong blocks and subsequently sliced into thin strips is usually fried, broiled or grilled and consumed despite its high fat content. Of course, as can be appreciated, the lean meat content of the bacon is subject to little or no control and is dependent on the natural condition of the animal. Accordingly, it is an object of the present invention to provide a new and improved meat product that conveniently takes the form of bacon and exhibits many of its characteristics yet can be produced in a far more economical manner with a substantially increased lean meat content and, in fact, in such a manner as to completely control the lean meat content of the resultant bacon-like product.

As will be seen from the subsequent description, the preferred embodiments of the present invention process overcome these and other shortcomings of prior art.

### SUMMARY OF THE INVENTION

The present invention is a meat product which has the appearance, as well as taste, mouth feel and texture characteristics of bacon, with a substantially increased lean meat content. There is provided a lean meat product having well below the total fat content normally associated with bacon. The meat product having less than a 25% fat content and preferably below a 15% by weight fat content.

The present invention further discloses a method of making the meat product described in the preceding paragraph.

The inventive method of the application, in its exemplary embodiment, for fabricating the product described above is as follows: Less than half, approximately 40%, of the total meat product is ground through a fine ground aperture plate. The fine ground meat is placed into a mixer with the balance of the lean meat. Seasonings and water are further added to the mixer and mixing proceeds for about five minutes. The mixture is next ground through a coarse ground aperture plate. The resulting mixture is transferred into pans that are placed into a smoke house. The method may also include the step of leveling the mixture once in the pan and prior to placing in the smoke house, in order to remove any air pockets in the mixture and so that the mixture within the pan is of the approximate same height.

### DESCRIPTION OF THE DRAWINGS

FIG. 1 is a flow chart illustrating a preferred overall procedure for making a bacon-like meat product in accordance with the present invention.

### DESCRIPTION OF THE PREFERRED EMBODIMENT

The present invention is a meat product and method for making the same. The present meat product has the appearance, as well as taste, mouth feel and texture characteristics of bacon, with a substantially increased lean meat content. Accordingly, the present invention provides a new and improved meat product that conveniently takes the form of bacon and exhibits many of its characteristics yet can be produced in a far more economical manner with a substantially increased lean meat content and, in fact, in such a manner as to completely control the lean meat content of the resultant bacon-like product. In addition, the fabrication of the meat product as disclosed results in satisfactory bonding of the components without the addition of known additives or supplements such as soy to enhance bonding characteristics.

Specifically, it will be noted that the meat product relates to a bacon-like product without the high fat content normally found in bacon. In the broadest context, the present meat product and method for fabricating the same consists of components configured and correlated with respect to each other so as to attain the desired objective.

The meat product is formed primarily of two basic components. The first is a lean meat product having less than a 25% fat content and preferably below a 15% by weight content. Obviously, the lean meat product is used to adjust and control the fat content of the final product. The second component consists of water, and various seasonings that may vary to suit the taste required in the final product. Exemplary seasonings include soft, sodium nitrite, sodium ascorbate or the like, sugar and other ingredients.

The method of fabricating the meat product will now be described in connection with a bacon-like product. However, those skilled in the art will immediately recognize that the invention is not so limited. For example, there are any number of varieties of types and sources of components that can be employed. For example, excellent results can be obtained when the lean meat is replaced by red beef. Additionally, other sources of meat such as veal, mutton, lamb, venison, etc. may also be utilized. For practical purposes, given the commercial popularity in this country for bacon and bacon-like products, the invention will be illustrated primarily in connection with the use of lean meat for fabricating bacon and bacon-like products.

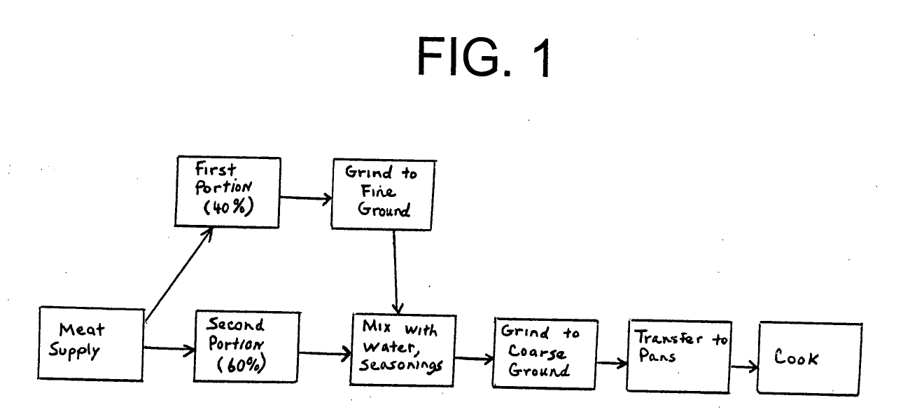

FIG. 1 illustrates a preferred procedure for forming a bacon-like meat product according to the invention. Initially, approximately 40% of the total lean meat product is set apart from the balance of the total lean meat product. For purposes herein, the 40% portion separated as described above shall be referred to as the “first portion,” and the remainder or balance of the lean meat product that being the remaining approximate 60% of the total lean meat product shall be referred to as the “second portion.”

The first portion is ground through a grinding device of generally known construction having a fine ground aperture plate. This is accomplished by placing the first portion of lean meat product into a conventional mixer. The contents are ground through the grinder. The grinder includes an aperture plate having ⅛ inch holes therewithin. The raw meat consisting the first portion is fed into the mixer and engages the grinder to be severed to a size which passes through the holes in the plate resulting in a fine ground.

The fine ground meat and the second portion of the lean meat are together placed in the mixer. Seasonings as described above are further added to the mixer as well as water. The inventor has found the appropriate volume of water is approximately 8 pounds water to approximately 100 pounds of the total lean meat. The inventor has also found the appropriate amount of seasoning is approximately 2.97 pounds of seasoning to approximately 100 pounds of the total lean meat.

The mixing is carried out by conventional techniques and involves simply mixing the fine ground meat with the balance of the lean meat, the seasonings, and water. The mixing preferably continues for about five minutes or such additional time as is required to expose the surfaces of the unground lean meat to the fine ground and seasonings.

The mixture is next ground through a coarse ground aperture plate. This is accomplished by grounding the mixed contents within the mixer through a grinder including an aperture plate having ½ inch holes therewithin, resulting in a coarse ground meat.

The resulting coarse ground meat is transferred into molds or pans preferably bake loaf pans. The pans are filled to approximately one half inch from the top. Once in the pan, the mixture is leveled using a known rolling pin or similar apparatus. Rolling the mixture as described accomplishes two objectives. First, the slight pressure on the mixture from the rolling pin will remove any air pockets contained within the mixture. Second, rolling the mixture with a rolling pin causes the mixture within the pan to have the approximate same height to assist the meat in cooking evenly as will be discussed.

The pan is placed in a conventional smoke house for smoking. A desirable smoking schedule is:
Warming the meat until the meat temperature is 100 [deg] F. and heating the meat at 100 [deg] F. for approximately 1 hour;
Warming the meat until the meat temperature is approximately 115 [deg] F. and heating the meat at approximately 115 [deg] F. for approximately 30 minutes;
Warming the meat until the meat temperature is approximately 130 [deg] F. and heating the meat at approximately 130 [deg] F. for approximately 30 minutes;
Warming the meat until the meat temperature is approximately 145 [deg] F. and heating the meat at approximately 145 [deg] F. for approximately 1 to 1½ hours; and
Allow the meat to cool down to approximately 90 [deg] F.

After smoking the meat, subsequent processing will normally include the removal of the product from the mold or pan. The product is frozen and tempered like regular bacon. The product is then sliced and packaged in the same way as bacon.

As disclosed, in order to avoid undesirable results, the preferred embodiment for fabricating the final coarse ground meat product includes re-grinding a mixture containing approximately 40% (the first portion) of fine ground meat with the balance (the second portion) of the lean meat product. For example, the inventor has found that increasing the volume of the first portion of lean meat from 40% to in excess of 60% is unacceptable and will cause the resulting product to be very tough. Likewise, the inventor has found that decreasing the volume of the first portion below 40% thereby increasing the volume of the second portion to in excess of 60% of the total lean meat product is unacceptable and will cause the resulting product to be chunky in appearance as well as chunky in mouth feel.

As indicated previously, the lean meat product of the present invention offers an alternative to the currently offered bacon product that normally has a high fat content. The present meat product has the appearance, as well as taste, mouth feel and texture characteristics of bacon, with a substantially increased lean meat content. Accordingly, the present invention provides a new and improved meat product that conveniently takes the form of bacon and exhibits many of its characteristics yet can be produced in a far more economical manner with a substantially increased lean meat content and, in fact, in such a manner as to completely control the lean meat content of the resultant bacon-like product.

Although the description above contains many specificities, these should not be construed as limiting the scope of the invention but as merely providing illustrations of some of the presently preferred embodiments of this invention. As previously mentioned, there are any number of varieties of types and sources of components that can be employed herein. For example, excellent results can be obtained when the lean meat is replaced by red beef. Additionally, other sources of meat such as veal, mutton, lamb, venison, etc. may also be utilized.

Thus the scope of the invention should be determined by the appended claims in the formal application and their legal equivalents, rather than by the examples given.

1. A low fat composite bacon-like meat product made by a process comprising the following steps in the order named:
(a) separating a lean meat product into a first portion and a second portion;
(b) grinding the first portion to a fine ground;
(c) mixing a mixture consisting of the fine ground first portion, the second portion, selected seasonings, and water;
(d) grinding the mixture to a coarse ground;
(e) transferring the coarse ground mixture to containers; and
(f) cooking and smoking said coarse ground mixture.

2. The method of claim 1, wherein the first portion comprising of about 40% to 60% of the total lean meat product, and the second portion comprising the balance of the total lean meat product.

3. The method as recited in claim 1, wherein the grinding step (b) comprises passing the first portion through a grinder's aperture plate having ⅛ inch holes therewithin.

4. The method of claim 1, wherein the grinding step (d) comprising passing the mixture through a grinder's aperture plate having ½ inch holes therewithin.

5. The method of claim 1, wherein the volume of said seasoning in the mixing step (c) is approximately 2.97 pounds of said seasoning to approximately 100 pounds of the total lean meat.

6. The method of claim 1, wherein the volume of said water in the mixing step (c) is approximately 8 pounds of said water to approximately pounds of the total lean meat.

7. The method of claim 1, wherein the smoking step (f) comprising incrementally heating the coarse ground mixture.

8. The method of claim 7, further comprising the steps of:
(a) warming the coarse ground mixture until such mixture's temperature is 100 [deg] F. and heating the coarse ground mixture at 100 [deg] F. for approximately 1 hour;
(b) warming the coarse ground mixture until such mixture's temperature is approximately 115 [deg] F. and heating the coarse ground mixture at approximately 115 [deg] F. for approximately 30 minutes;
(c) warming the coarse ground mixture until such mixture's temperature is approximately 130 [deg] F. and heating the coarse ground mixture at approximately 130 [deg] F. for approximately 30 minutes;
(d) warming the coarse ground mixture until such mixture's temperature is approximately 145 [deg] F. and heating the coarse ground mixture at approximately 145 [deg] F. for approximately 1 to 1½ hours; and
(e) allow the coarse ground mixture to cool down to approximately 90 [deg] F.

9. The method of claim 1, wherein the seasonings comprises a material selected from the group consisting of salt, sodium nitrite, sodium ascorbate, sugar and mixtures thereof.

10. The method of claim 1 including the steps of cooling the smoked mixture and slicing and packaging the cooled smoked mixture.

11. The method of claim 10, wherein the smoked mixture is sliced into thin strips suited for use as a substitute for bacon.

12. The method of claim 1 further including the step of removing any air pockets in the coarse ground mixture after the transferring step (e).

13. The mixture of claim 12, wherein the air pockets are removed from the mixture using a rolling pin.

14. The method of claim 1, wherein said lean meat product having a fat content not greater than about 25% by weight of fat, based upon the total weight of the lean meat product.

15. The method of claim 1, wherein the mixing step (c) continues for about 5 minutes or until surfaces of the second portion are exposed to the fine ground first portion and seasonings.

16. A processed coarse ground meat composition comprising a supply of lean meat having less than a 25% fat content, water, and seasonings, wherein approximately 40% to 60% of the meat supply comprising a fine ground portion.

17. The meat composition as recited in claim 16, wherein the 40% to approximately 60% of the meat supply is passed through a grinder including an aperture plate having ⅛ inch holes therewithin forming the fine ground portion.

18. The meat composition as recited in claim 16, wherein the volume of said seasonings is approximately 2.97 pounds of said seasonings to approximately 100 pounds of the meat supply.

19. The meat composition as recited in claim 16, wherein the volume of said water is approximately 8 pounds of said water to approximately 100 pounds of said meat supply.

20. The meat composition as recited in claim 16, wherein the seasonings comprises a material selected from the group consisting of salt, sodium nitrite, sodium ascorbate, sugar and mixtures thereof.

21. The meat composition as recited in claim 16, wherein said composition as sliced into thin strips suited for use as a substitute for bacon.
